(19) United States
(12) Patent Application Publication
(10) Pub. No.: US 2016/0306954 A1
(43) Pub. Date: Oct. 20, 2016

(54) METHODS AND SYSTEMS FOR MULTI-KEY VERITABLE BIOMETRIC IDENTITY AUTHENTICATION

(71) Applicant: IDENTITY AUTHENTICATION MANAGEMENT, St. Peters, MO (US)

(72) Inventor: Charles Curtis Hawkins, St. Peters, MO (US)

(21) Appl. No.: 15/101,038

(22) PCT Filed: Dec. 2, 2014
(86) PCT No.: PCT/US14/68151

§ 371 Date: Jun. 2, 2016

Related U.S. Application Data
(60) Provisional application No. 61/910,480, filed on Dec. 2, 2013.

(51) Int. Cl. G06F 21/32

(52) U.S. Cl. CPC G06F 21/32; H04L 9/3239

(57) ABSTRACT

A technology is disclosed that addresses the problem of identity verification while respecting the need to minimize intrusion upon the privacy and civil rights of users. The technology allows for quick deployment while minimizing the amount of information, capital, and time required for deployment by creating an unique identity code by combining biometric analytical data, without the need to save, transmit, or compare biometric images, with basic personal information such as name and account number to create readily to transmission and verification by issuing agencies or business.

### CROSS-REFERENCE TO RELATED APPLICATIONS

This PCT application entitled Methods and Systems for Multi-key Veritable Biometric Identity Authentication claims benefit of the provisional application 61/910,480, filed Dec. 2, 2013. The provisional application is fully incorporated by reference in its entirety.

### BACKGROUND OF THE INVENTION

1. Field of Disclosure

The present disclosure relates to a method and a system for identity authentication that comprises a biometric data.

2. Background

Identity authentication—validating that a user is in fact who he claims to be—has become a particularly pressing problem with the growth of remote transactions over the Internet. Previous approaches have used, e.g., passwords, PINs, and other information (generically, “challenge queries”) to address this problem, but such knowledge-based methods all suffer from fundamental problems. Users can forget the correct response, necessitating intervention to reset challenge queries, and thereby incurring costs by any parties facilitating the transaction. Furthermore, anyone with the appropriate knowledge can masquerade as the legitimate user, so that stolen, guessed, or reverse-engineered passwords or other authenticating information present a serious security breach.

Worse, while strong passwords are difficult to guess, they are also difficult to remember, leading many users to employ the same strong password on numerous sites. Compromise of one site's challenge query thus poses a threat to all other sites on which the user has specified the same response, and those other sites have no way of knowing if or when their security is at risk.

One way to strengthen knowledge-based authentication is to use biometric data, viz., something of the user, rather than something he knows. Fingerprints, for example, can be used either alone or in conjunction with knowledge-based authentication to mitigate this security problem, but their use gives rise to new problems. A fingerprint image contains a lot of data, which poses a burden on network traffic and storage needs at the relying party and hinders scalability. In addition, analysis of a fingerprint imposes overhead on the computing power at the relying party. Even worse, storage of such images at a variety of sites, including retailers, raises legitimate privacy concerns amongst users, since fingerprints can be used to identify individuals uniquely. In addition, biometric data such as fingerprints can be stolen. Last, unlike passwords or certificates, biometric data cannot be revoked, which leads to a cross-domain security risk; a user cannot change, e.g., his fingerprints, so a data breach at one site can compromise all other sites at which the user has used the same biometric data for authentication.

U.S. Pat. No. 6,507,912 to Matyas et al. discloses methods and systems of generating key-dependent biometric data samples.

U.S. Pat. No. 6,687,375 to Matyas et al., discloses generating a user-dependent cryptographic key from user-specific information that may be biometric data.

U.S. Pat. No. 7,120,607 to Bolle et al., discloses a method of generating cancelable biometric authentication through distorting the user's biometric data.

U.S. Pat. No. 7,391,891 to Hillhouse provides a way of using the coordinates, angles, and types of biometric minutiae in the identification of a user.

U.S. Pat. No. 7,711,152 to Davida and Frankel, discloses an identity authentication system that uses biometric data as a cryptographic key, and does not require storage of the pattern to be identified in either an on-line database or offline on a token.

U.S. Pat. No. 7,783,893 to Gorelik and Fursenko, discloses a method of shuffling arrays of biometric data according to a user's input.

U.S. Pat. No. 8,316,050 to Caveney, discloses the transformation of a biometric scan into a biometric code.

U.S. Pat. No. 8,359,475 to Griffin provides a way of generating a cancelable biometric template through use of a transformation engine.

U.S. Pat. No. 8,631,243 to Baldan and Vendittelli discloses a biometric template matching method that employs data regarding the coordinates and orientation of minutiae.

U.S. Pat. No. 8,745,405 to Pizano and Sass discloses a method for generating a key from biometric data.

U.S. Pat. No. 8,812,864 to Adams et al. discloses a method of authentication that involves using biometric data to encrypt a character sequence associated with a smart card.

U.S. Pat. No. 8,823,489 to Liu discloses a method of comparing biometric templates that may differ in their degree of rotation.

U.S. Pat. No. 8,842,887 to Beatson et al., discloses encryption of a biometric template by rotation through a specified angle.

Each of these references is hereby incorporated by reference in its entirety.

There is a continuing need for a way to authenticate the identity of a user that is difficult (or ideally impossible) to steal, guess, or reverse-engineer, that does not substantially increase network traffic or storage requirements, does not engender privacy concerns, and that addresses the cross-domain security risk of using non-revocable biometric data.

### BRIEF SUMMARY OF THE INVENTION

The disclosed system and method address this need by providing a way to characterize biometric data for identity authentication that yields a small file size, cannot be used to identify the user, yet provides strong authentication of the user's identity and can be revoked.

### BRIEF DESCRIPTION OF THE DRAWINGS

FIG. 1 is a block diagram of the enrollment process by an enrollment unit in creating an identity authentication code.

FIG. 2 is a block diagram of the enrollment process.

FIG. 3 is a block diagram of the transaction process by a transaction unit.

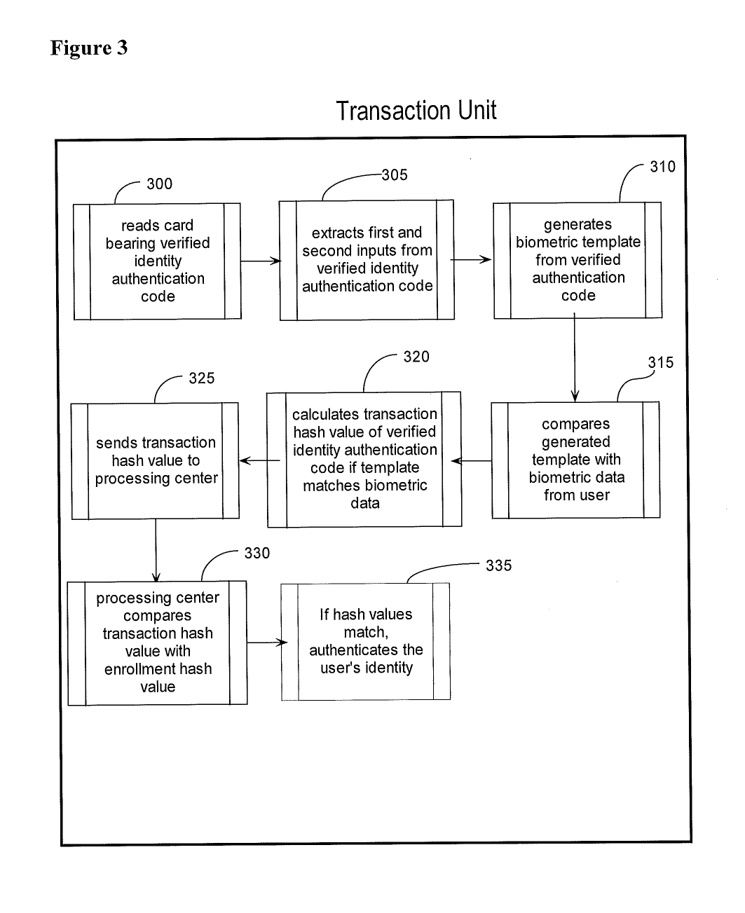

### DETAILED DESCRIPTIONS OF THE INVENTION

### Definitions

Unless otherwise specified, technical terms take the meanings specified in the McGraw-Hill Dictionary of Scientific and Technical Terms, 6^{th} edition.

“Biometric data” here means information arising from physical properties of an individual, such as fingerprints, facial features, vascular patterns in fingers, tear patterns on the cornea, voice prints, iris structure, retinal vasculature, heartbeat, brain waves, and the like.

“Minutia(ae)” here refers to the details of biometric data that differ from person to person, and hence can be used to distinguish between people. The minutiae of fingerprints, for example, include loops, whorls, and deltas, the relative positions of which differ between individuals.

“Hash function” as used here refers to a function that maps digital input data to digital data of a given size (a “hash value”) with slight differences in input data resulting in large differences in the hash value, from which it is considered practically impossible to deduce the input data (https://en.wikipedia.org/wiki/Hash_function and https://en.wikipedia.org/wiki/Cryptographic_hash_function, both accessed on Oct. 29, 2014, and incorporated herein by reference).

### Enrollment

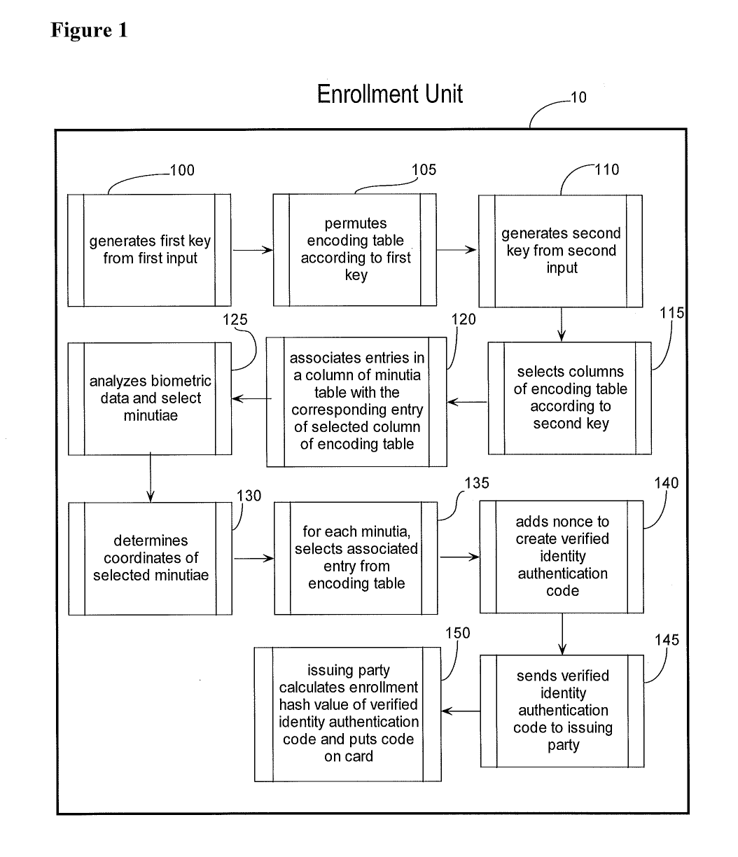

The identity authentication algorithm entails use of several keys that are generated in the course of enrollment (FIG. 1).

Enrollment begins at an enrollment unit 10 (typically at a bank or government agency) with a knowledge-based first input to the identity authentication algorithm, which generates from it a first key 100 according to a first input algorithm, the details of which are not critical. In one embodiment this first input is the user's name, but in others it could be a credit card number, Social Security number, or other information known to the user, with the choice not being critical. For example, if the first input is the user's name, in a simple first input algorithm the letters of the user's name could be associated with numbers, and the numbers summed to yield the first key.

The identity authentication algorithm then uses this first key to permute the entries in an encoding table (105), a first rectangular N x M matrix (where N may or not equal M), according to a permutation algorithm to yield a permuted encoding table. The details of the permutation algorithm are not critical, nor is the nature of the entries in the encoding table, as long as the entries are not all identical. They could be alphanumeric characters, such as letters of the Roman alphabet and Arabic numeric characters, optionally including punctuation and mathematical symbols, or letters or symbols from other languages, or they could be ASCII or Unicodes, or binary or hexadecimal values. In some embodiments this first permutation algorithm is a symmetry operation of the first matrix of first entries, where the symmetry operation could be a translation, a proper rotation, or an improper rotation, a rotation and translation along a helical axis, a reflection and translation along a glide plane, as those familiar with space groups will appreciate.

The identity authentication algorithm next uses a knowledge-based second input to generate a second key (110) according to a second input algorithm, the details of which again are not critical. As with the first knowledge-based input, the nature of this second input is not critical, and can be a number associated with an account, a driver's license, an insurance policy or other alphanumeric information, but preferably the second input differs from the first input and preferably is unique to the user.

The identity authentication algorithm use the resulting second key to select a subset of entries from the permuted encoding table (115), and to associate each selected entry with a minutia in a minutia table (120) (an N′×M′ matrix, whereas N′ and M′ can be the same or different), where the minutia table comprises various canonical minutiae characteristic of the type of biometric data being used. For example, if the biometric data should come from fingerprints, this minutia table could comprise loops, whorls, deltas and other fingerprint minutiae in various orientations. In one embodiment the minutia table is an augmented matrix wherein each matrix element comprises a minutia and an associated entry from the permuted encoding table. Alternatively, and equivalently, the association between the first and second matrices could be effected by construction of an association matrix that maps elements of the first matrix to corresponding positions of the second matrix.

The identity authentication algorithm next generates a third key from biometric data derived from the user, wherein a third input algorithm selects certain minutiae (125) from those data. In one embodiment those minutiae derive from fingerprints, and for purposes of concreteness, the following description will refer to fingerprints, but other biometric data can also be used, as those skilled in the art will appreciate.

For fingerprint data, each of the selected minutiae (the number of selected minutiae is not critical although increased number correlates with increased complexity for the code) is characterized by its type (e.g., loop, whorl, delta, etc.), its orientation with respect to an axis, and its coordinates, with respect to some reference point and coordinate system (130). For example, the reference point could be a set point on a grid associated with a scanning device used to collect the biometric data, or it could be one of the minutiae, thereby yielding an ordered pair of coordinates (or, equivalently, vectors) describing the relative positions of other minutiae. For example, the reference point could be selected as the selected minutia nearest the center of the scan—although neither the choice of reference point nor the coordinate system (e.g., Cartesian, or polar) is critical.

The identity authentication algorithm then maps the selected minutia(e) of the biometric data to the corresponding canonical minutiae of the minutia table, and uses the encoding table entry corresponding to that canonical minutia as part of an identity authentication code (135). As an example, if a right-facing bifurcation has been assigned a representative character of “$,” that character would then be assigned to that location on the print to represent the minutia in the identity authentication code.

The identity authentication algorithm finally adds as a fourth key, a nonce (140) to ensure that different users' identity authentication codes are disjoint, and to generate thereby a verified identity authentication code. The nonce could include such items as a reader ID of the enrollment device used to enroll the user, what version of software was used, when the enrollment took place, which authentication unit was used, when the authentication took place, a transaction number, a sequence number, and/or a random number. In this fashion the same biometric data, such as a fingerprint, yield different results for the verified identity authentication code. The resulting verified identity authentication code in one embodiment has 38 to 42 bytes and derives from nine-minutiae.

Then in one embodiment the identity authentication algorithm sends the verified identity authentication code to the issuing party (145), who then uses a hash function to calculate the enrollment hash value of the verified identity authentication code (150) and stores the enrollment hash value associated with the user's identity. The issuing party would put the user's identity authentication code on a card, thumb drive, or other device for use in future transactions.

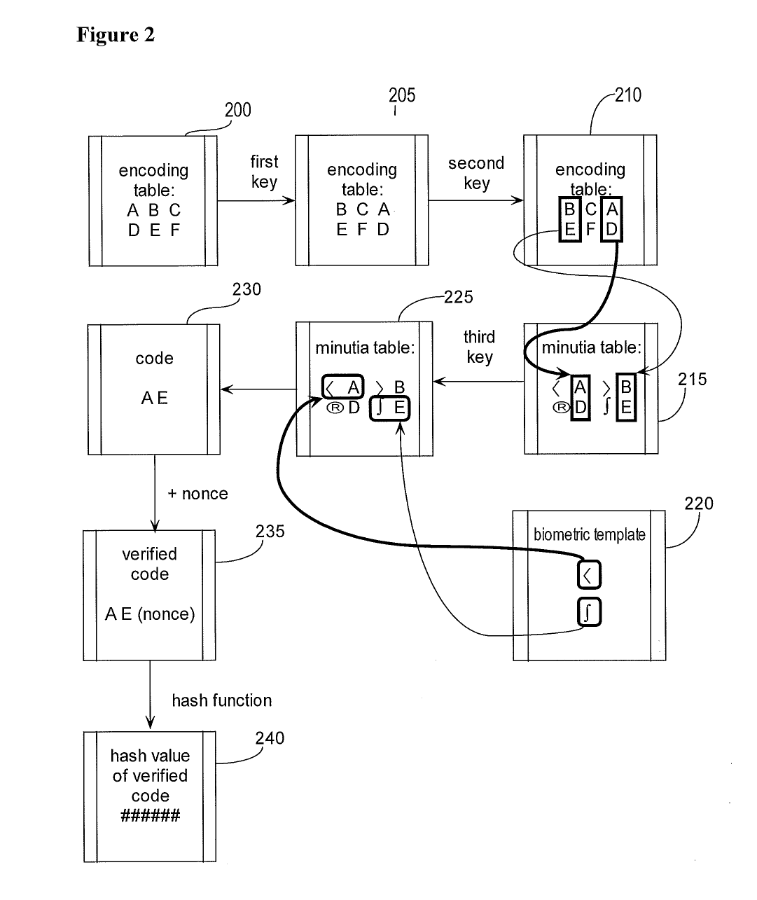

The enrollment process is described further in FIG. 2. After provision of a first key, the identity authentication algorithm permutes encoding table (200) to generate permuted encoding table (205). Following entry of a second key, the identity authentication algorithm selects some subset (210) of the permuted encoding table (205), and associates members of that subset with elements of a minutia table to form an augmented minutia table (215). The identity authentication algorithm then generates from biometric data a biometric template (220), from which it extracts minutiae, characterizes them by position and orientation, and finds the corresponding canonical minutia in the minutia table (225). The identity authentication algorithm then extracts the encoding table entries of the augmented minutia table (215) that are associated with each minutia (200) to produce an identity authentication code (230). The identity authentication algorithm adds a nonce to the identity authentication code (235) to generate a verified identity authentication code. Last, a hash function is then used to calculate a hash value of the verified identity authentication code (240), in one embodiment at an issuing party or alternatively at the enrollment unit.

In one embodiment, users enroll at an enrollment center of an issuing party, where users provide proof of their identity along with biometric data, such as a fingerprint, voice print, or the like at an enrollment unit, which may be a tablet, laptop computer, or other device that can implement the identity authentication system, such as an integrated circuit. Each enrollment unit may, if desired, have an enrollment unit ID to facilitate tracking the location and usage of the enrollment unit, and to permit disablement of the unit if, for example, it is being used in a fraudulent manner. Enrollment centers may be, for example, businesses, such as banks, or government agencies, such as motor vehicle departments, but others can be envisaged.

### Transaction

Authentication of a user's identity takes place at a transaction unit (20), which may or may not be the same as an enrollment unit. The transaction unit (20) reads the card or other device bearing the user's verified identity authentication code (300), from which the identity authentication algorithm extracts the first and second inputs (305). The identity authentication algorithm generates a biometric template from the verified identity authentication code (310), and compares that generated biometric template with a transaction biometric template arising from biometric data supplied by the user at the time of the transaction (315). If the generated biometric template matches the transaction biometric template the identity authentication algorithm then calculates a transaction hash value of the verified identity authentication code (320) and sends the transaction hash value to a processing center (325). The processing center compares the transaction hash value with the enrollment hash value (330) to authenticate the identity of the user.

This description has focused on use of fingerprints, for the sake of concreteness, but those of skill in the art will recognize that the disclosed method and system can be used with other types of biometric data. For example, the biometric data could arise from the vasculature of, e.g., the retina, or other structure of the eye. Similarly, voice prints or brain waves could be recorded in the time domain and Fourier transformed to the frequency domain, where minutiae might then constitute the pattern of relative amplitudes of the Fourier components as a function of frequency in the frequency domain.

As is evident from the foregoing description, certain aspects of the present disclosure are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present disclosure.

What is claimed is:

1. A method of identity authentication comprising
permuting encoding entries in an encoding table based on a first identifier to generate a permuted encoding table;
selecting a subset of encoding entries of the permuted encoding table based on a second identifier;
associating at least one minutia entry in a minutia table with a member of the subset;
correlating at least one minutia of a biometric template to a minutia entry; and
using the corresponding selected encoding entry to generate an identity authentication code.

2. The method of claim 1, further comprising
transforming the first identifier into a first value according to a first-identifier-transformation algorithm;
transforming a second identifier into a second value according to a second-identifier-transformation algorithm; and
generating the identity authentication code by mapping each minutia to the corresponding encoding in the minutia table according to a minutia-mapping algorithm.

3. The method of claim 1, wherein the biometric template is generated from biometric data come from the user's hands, eyes, face, heart, brain, or vocal cords.

4. The method of claim 3, wherein the biometric data come from the user's fingerprints, iris scan, retinal scan, scleral scan, heartbeat, brain activity, or voice print.

5. The method of claim 4, wherein the biometric data come from a fingerprint.

6. The method of claim 1, wherein the digital values are selected from the group consisting of alphanumeric, binary, decimal, hexadecimal values, and a combination thereof.

7. The method of claim 1, further comprising adding a nonce to the identity authentication code to produce a verified identity authentication code.

8. The method of claim 7, wherein the nonce comprises at least one member selected from the group consisting of a verification key, a reader identification number, a transaction number, a sequence number, a time/date stamp, and a combination thereof.

9. The method of claim 7, further comprising using a hash function to create a hash value for the verified identity authentication code.

10. The method of claim 9, wherein the hash function is SHA-3.

11. The method of claim 1, further comprising
providing the first identifier, the second identifier, biometric data, and a verified identity authentication code to a point-of-transaction unit;
creating a calculated biometric template based on the verified identity authentication code, the first identifier, and the second identifier; and
comparing the calculated biometric template with the biometric data from an individual to determine if the calculated biometric template matches the biometric data from the individual.

12. The method of claim 11 further comprising
using a hash function to create a hash value for the verified identity authentication code;
transmitting the hash value to the issuer; and
comparing the transmitted hash value with the hash value on file with the issuer.

13. A system for authenticating the identity of a user comprising a device adapted to implement the method of claim 1.

14. A non-transitory computer-readable medium storing instructions to implement the method of claim 13.

15. The non-transitory computer-readable medium of claim 14, wherein the medium is selected from the group consisting of computer RAM, a hard disk, a USB drive, an optical disk, and an integrated circuit.

16. The non-transitory computer-readable medium of claim 15, wherein the medium is an integrated circuit.
